(19) United States
(12) Patent Application Publication
(10) Pub. No.: US 2007/0183873 A1
(43) Pub. Date: Aug. 9, 2007

(54) Device for automatically picking up objects

(76) Inventor: Andre Colens, Rixensart (BE)

Correspondence Address: ARMSTRONG, KRATZ, QUINTOS, HANSON & BROOKS, LLP;Intellectual Property Law Offices, Suite 220, 502 Washington Avenue, Towson, MD, 21204, US

(21) Appl. No.: 11/707,707

(22) Filed: Feb. 16, 2007

Related U.S. Application Data
(63) Continuation of application No. 11/077,866, filed on Mar. 11, 2005, now abandoned.
Application No. 11/077,866 is a division of application No. 10/030,745, filed on Dec. 14, 2001, now abandoned.

(30) Foreign Application Priority Data
Jun. 17, 1999 (BE) 9900422

(51) Int. Cl. B60P 1/00

(52) U.S. Cl. 414/437

(57) ABSTRACT

A system for picking up golf balls over a golf practice green consists of an automatic mobile machine equipped with a motor and a power source, for example a rechargeable battery, and provided with an onboard computer. The machine carries a mechanical device for gripping and storing the golf balls in a container, a device for emptying such container, a device for detecting the limits of the surface for picking up. The system further comprise at least a station for discharging the balls picked up and preferably a station for recharging the rechargeable batteries. Both stations are advantageously integrated to each other.

### CROSS REFERENCE TO RELATED APPLICATION

The present application is a continuation of application Ser. No. 11/077,866filed Mar. 11, 2005, which is incorporated in its entirety by reference herewith.

Golfers practice their “drives” from a reserved space and hit balls to distances which are typically of 50 to 200 meters. These balls have to be regularly picked up and returned to the driving site.

Special golf ball pick up machines, particularly operating on practice greens -are already known. They generally operate with a system which comprises spaced flexible disks having the width of a golf ball (see for instance U.S. Pat. No. 5,711,388). The disks rotate and are vertically fitted on a horizontal shaft, perpendicular to the forward movement of the machine, the latter being pulled by a self-propelled vehicle or pushed by hand.

In order to prevent an excessive number of balls from being in circulation, the picking up action has to be performed regularly, which involves a considerable labor cost and a regular disturbance for golf players.

Hence, there exists an actual need for a system that picks up balls in a fully automatic manner, and that can operate without interrupting the players and with no risk of accidents due to strong drives.

This invention provides a fully automatic system for picking up and returning balls, which needs no labor and allows the players to keep on practicing while balls are picked up.

In a more general manner, the invention provides a system for picking up objects on a delimited surface, consisting of an automatic mobile machine equipped with a motor and a power source, e.g. a rechargeable battery, and provided with an onboard computer. The machine carries a mechanical device for gripping and storing objects in a container, a device for emptying said container, a device for detecting the limits of the surface for picking up. The system further comprises at least one station for recharging the rechargeable batteries and one station for unloading the picked up objects.

According to an aspect of the invention, the system includes a self-contained mobile machine which circulates in a random or pseudo-random manner, over the ball pick-up surface.

In a well-known manner, the surface is preferably delimited by a peripheral wire wherein a low frequency signal circulates to be detected by the machine. Other systems for delimiting the operating surface may be used, including physical obstacles, such as those described in patent application no. PCT/BE91/00068, which discloses a robotic lawn mower.

The pick up machine includes a chassis and driving and guiding members which are known per se, e.g. like those described in patent applications PCT/BE91/00068 and PCT/BE98/00038.

The mowing system disclosed in the above documents is replaced by a system for picking up balls. The system for picking up balls consists, for instance, of a roller formed by a set of parallel flexible disks, which have a suitable profile and are spaced at a distance which is equal or slightly lower than a ball diameter. As the machine advances, the flexible disk system which rests on the ground is passively driven into rotation and rolls over the balls it finds in its way. The roller wedges the latter between two adjacent flexible disks which, by the ascending circular movement and the effect of deviation members in the descending path, bring them back into a collecting basket supported by the machine. The flexible disk system is preferably fitted on one or more joints, or is anyway flexibly mounted, which allows it to stay in contact with the ground in case of irregularities. The collecting basket has an opening on its bottom side, which is controlled by the onboard computer.

In accordance with one embodiment, the flexible disk system comprises an articulated shaft which is adapted to be lifted, e.g. by means of a screw jack. In case of a change of direction the computer forces the flexible disk system to be lifted up to avoid a considerable friction with the ground, as well as the degradations of the grass surface and the additional power consumption that may result therefrom.

When the basket is full or the batteries of the machine have to be recharged, the computer for controlling the forward movement of the machine triggers an algorithm which allows to return it toward a fixed location (station). The ball filling limit in the collecting basket may be detected, for instance by an IR transceiver system connected to the microcomputer.

According to one embodiment, the machine returns to the recharging station by looking for the peripheral wire, i.e. by running, for instance, a straight path in a random manner and after detecting it, by following it at a fixed distance until reaching the terminal or recharging station. The latter may advantageously be connected to and integrated with a ball recovery station.

In fact, according to a preferred embodiment, once the terminal has been detected, e.g. by contact, the machine stops and possibly finds a more accurate position. The computer controls the door opening, allowing the basket to be emptied and maintains the machine in a recharging state until batteries are full. After recharging, the machine starts again for a new pick up cycle, and covers the surface of the practice green in a random or quasi-random manner.

In accordance with other embodiments, currently less preferred, the machine can reach the recharging station by other means, e.g. by analyzing a magnetic field with a possible induction recharge (see for instance U.S. Pat. No. 5,869,910) by radio control or by infrared signal detection.

In the latter case, the machine of the invention incorporates a system which allows it to be controlled and positioned relative to a fixed station which operates by means or a directional infrared beam, transmitted by the fixed. station, the mobile robot being provided with a directional infrared transmission detection system (i.e. detectors) which is connected to the microcomputer incorporated in the robot, said robot being displaced over an operating surface in a substantially random manner, and said microcomputer comprising an algorithm for controlling the return to the fixed station by displacing the robot toward the direction of transmission of said infrared beam. The infrared beam may be a narrow directional beam and the detection system may be advantageously situated on the chassis at the center of rotation of the robot, turned toward the moving direction of the robot, the accurate positioning in the fixed station being obtained by rotating the machine about a vertical axis according to an algorithm based on the detection of the narrow beam, e.g. through 2 to 12°.

This system may operate with at least two beams having substantially different directions, transmitted from or near the fixed station, the less directional beam/s being used to get closer to the fixed station, while the more directional beam/s are used for the final accurate robot positioning step, relative to said fixed station.

The machine of the invention may operate while balls are being driven. The machine has a lower profile, of little significance as compared with classic pulled or towing machines, and the collision with a ball is thereby reduced. Moreover, the shell of the machine, e.g. made of plastic, possibly covered with foam, is conceived in such a manner as to be able to support the impact of golf balls without being damaged thereby.

At certain times, it might be desirable that the surface be totally clear of balls, e.g. to mow the lawn in a conventional manner. In this case, the recovery on a random or quasi-random path system is no longer desirable. A systematic path system may be used here to cover the whole surface in an optimized time.

For example, the machine may follow the peripheral wire at a certain distance from the latter. Thanks to a constant measurement of the domain of a peripheral wire for delimiting the working surface such as the one described in patents EP 0550 472 B1 and 0 744 093 B1, the machine constantly determines its distance from the wire and may increase the latter after each run. Balls will be recovered in parallel bands from the periphery inwards.

More precisely, according to the latter method, at first the machine is positioned along the peripheral wire. Once the machine is started, the onboard computer periodically measures, in a well-known manner, the width of the signal transmitted by the peripheral wire. This measurement allows the onboard computer to determine its distance from the wire and to control the direction of the machine in order to maintain a fixed distance from the wire.

If the length of the wire has been first entered into the memory of the onboard computer, the latter may determine with a reasonable accuracy the moment in which a turn has been completed by the mower along the wire. Then, the mower can move away from the wire to a distance equal to the cutting width in such a manner as to be able to perform a new loop at a distance from the wire which is increased by the cutting width. Hence, the operation may be repeated by increasing every time the distance between the mower and the peripheral wire, ideally until reaching the center of the area to be mowed.

According to a variant embodiment, the length of the above wire shall not be necessarily entered into the computer. In fact, said length may be determined by the onboard computer. by integrating the speed differences between the driving wheels of the machine (changes of direction) until the total change reaches or exceeds 360°. To this end, the system may also advantageously integrate a magnetic or inertial compass.

The invention will be further described with reference to the following embodiment, and referring to the drawings annexed by way of non-limiting examples.

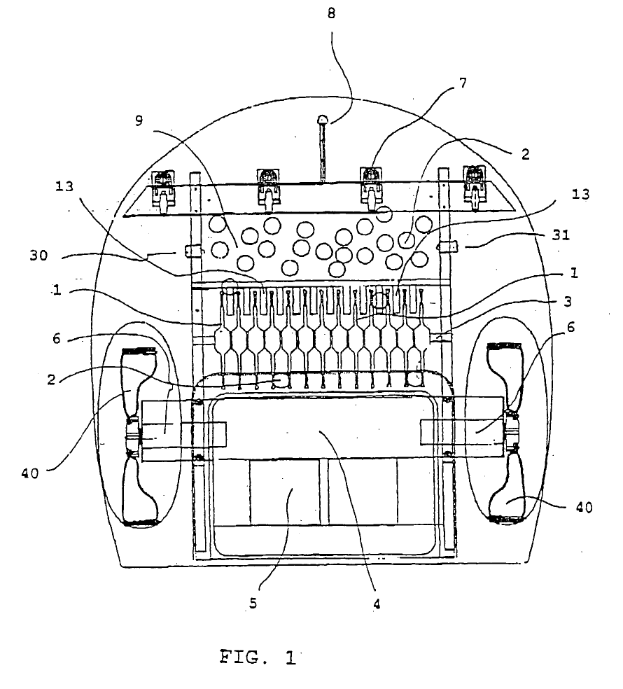

FIG. 1 is a bottom view of the machine of the invention.

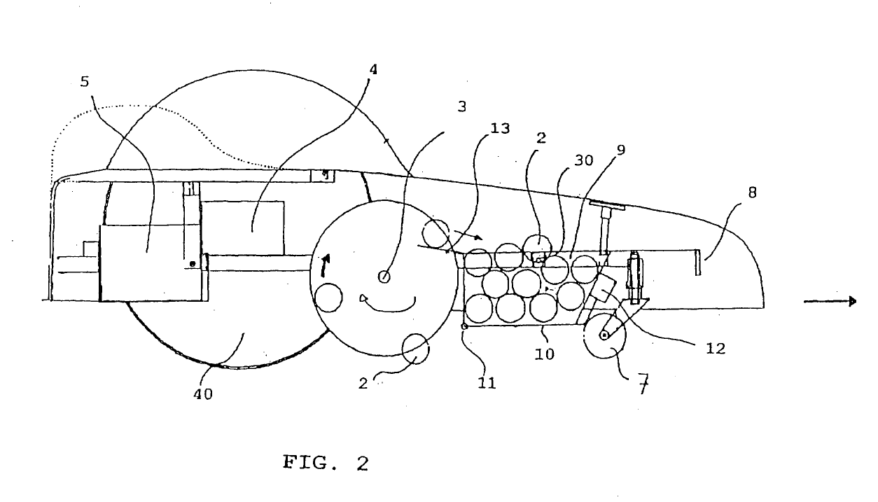

FIG. 2 is a side sectional view of the machine as shown in FIG. 1.

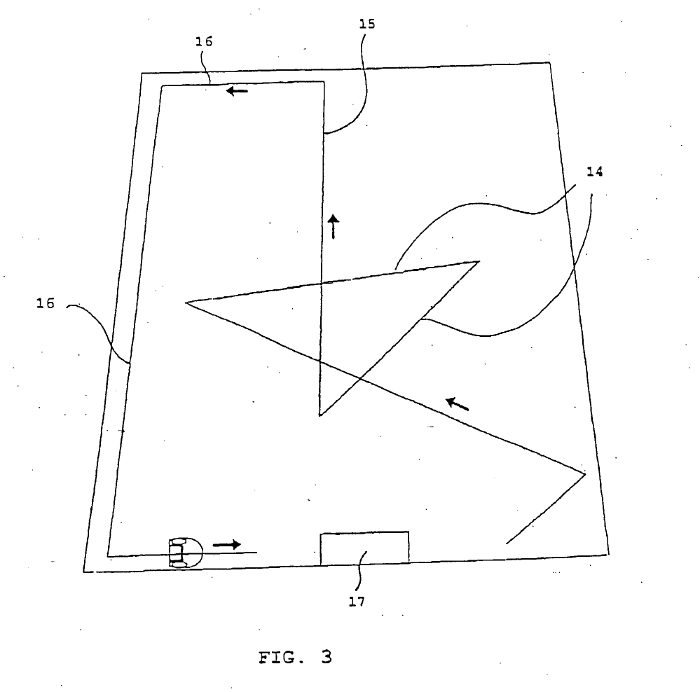

FIG. 3 shows the path followed by the machine.

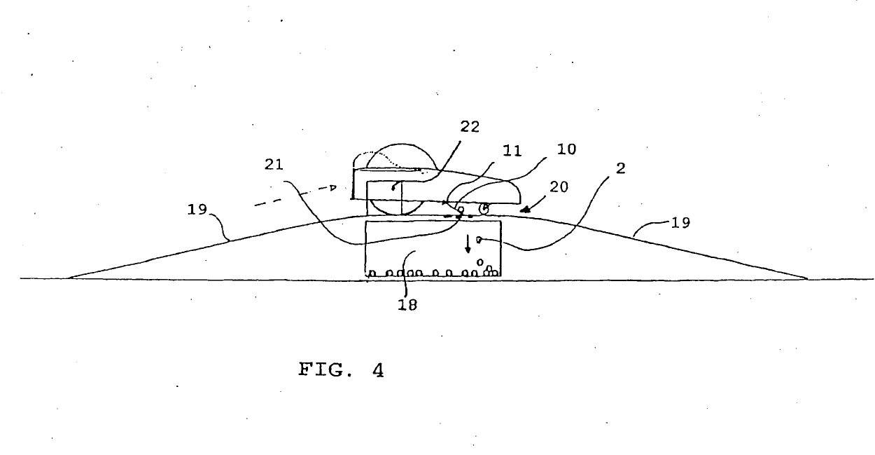

FIG. 4 shows an example of electric recharging and golf ball unloading station.

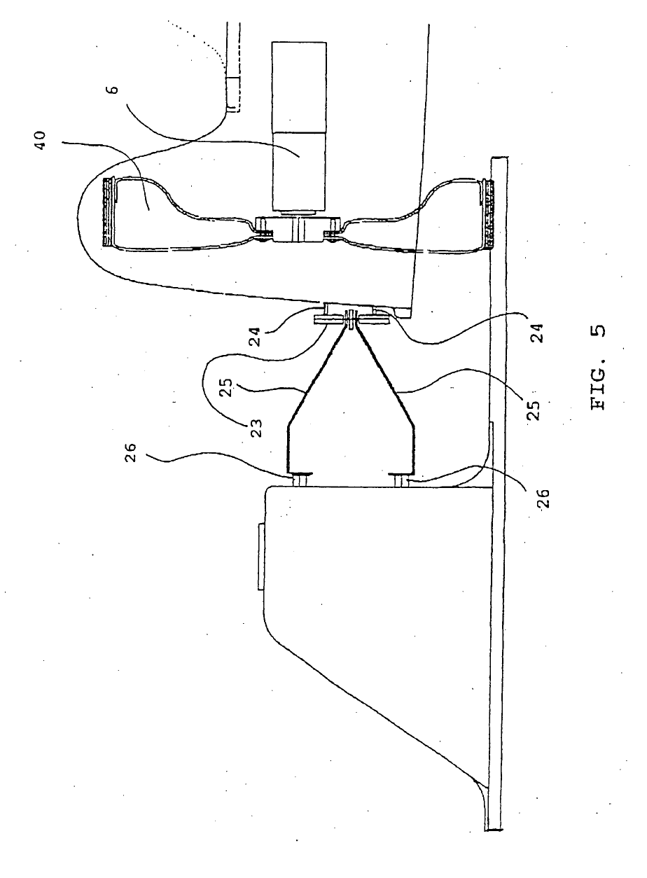

FIG. 5 shows a recharging system in detail.

FIG. 1 is a bottom view of the machine of the invention. It shows the flexible disks 1, the balls which are wedged between the disks, the transverse disk rotation shaft 3, which is preferably link to the chassis in a non rigid manner, the case comprising the control electronics and the onboard computer 4, the batteries 5, the motors for the wheels 6, the idle rollers 7 mounted at the front part, the peripheral wire detector 8, the optical basket fill detector 30, 31, consisting of an infrared transmitter and receiver.

FIG. 2 is a sectional side view of the machine or FIG. 1. The ball receiving basket 9 is visible herein, provided at its bottom wall with an opening door which pivots about the axis 11 and whose opening is controlled bv the screw jack 12. The fingers 13 situated on the circular path of the wedged balls extract the balls out of the disks to let them fall into the basket 9.

FIG. 3 shows an example of the machine path. This path is typically of the random type. When the machine is filled up with balls, and/or when the battery is sufficiently empty, the machine looks for the peripheral wire 15 and follows it until it detects the station 17.

FIG. 4 shows one embodiment wherein the station is raised so that a container 18 designed to collect the balls may be introduced thereunder. The ramps 19 allow the machine to reach the platform 20 in which the recharging station is situated. The platform 20 is fitted with a grid 21 through which the balls released from the basket opening 9 may reach the container or the ball return duct.

FIG. 5 shows the machine connected to the recharging station. While following the peripheral wire, and at the station, two brushes 23 at the sides of the machine come in contact with two guiding rails 24 mounted on each flank of the machine. By providing rails on the two flanks allows the machine to reach the station from either direction. The brushes 23 are mounted on the station via the arm 25 fitted to the case in a flexible manner in 26, which allows the arm to pivot when the machine contacts it. The onboard computer constantly checks the tension on the brushes 23. Whenever a tension is detected, the presence of rails, hence of the station, is acknowledged, and this allows the computer to stop the machine.

The ball unloading system may be advantageously connected to an automatic ball return system in the immediate proximity of the players. This system may include slightly inclined ducts, which convey the balls by gravity. As mentioned above, a recharging station which is situated appreciably higher than the ball driving site, and accessible through ramps, will be particularly suitable to this end.

Nevertheless, a receiving tub at ground level or a bowl in the ground may be provided, the tub or the bowl being equipped with a ball lifting system, e.g. a feed screw, a band conveyor, or the like, to bring balls into the containers or the return ducts.

It shall be also appreciated that the system described herein may be adapted to collect objects other than golf balls. Particularly, by modifying the system, these objects might be rubbish or vegetables.

Hence, the mechanical gripping device may consist of a rotary brush provided with spikes, radially arranged around the shaft of said brush. The spikes are adapted to pierce objects situated on said surface, and said objects are dragged along into a circular movement, released from the spikes by fined elements which are engaged between the spikes, and deviate the objects toward a storage device. The objects may be dead leaves or pieces of paper.

Also, it shall be understood that the system of the invention may be connected to a mowing system, possibly carried by the same chassis. An automatic mowing device as described in the above PCT applications may be developed separately, while using the same peripheral wire and the same discharging station.

It shall be further understood that the robot motor may be associated to a power source other than a rechargeable battery, for instance a fuel cell, or a thermal or hybrid motor.

According to another variant, the system of this invention would not include a driving means of its own, but would be towed by a mobile mowing robot whereto it would possibly be linked.

1. A system for picking up and collecting golf balls, in a golf practice without interrupting the players comprising an automatic mobile machine provided with an on-board computer and a power source, said machine having mechanical means to pick up and store said golf balls, the machine being programmed to move in a substantially random said golf practice to pick up and store said golf balls, in a container and to return, and automatically unload, by gravity action, the golf balls, at a station, said station being provided with recharging means for said power source wherein the machine is also programmed to switch to a mode where a systematic path is followed to cover a whole surface to be totally clear of balls.

2-13. (canceled)

14. The system of claim 1, wherein dead leaves and paper sheets are also collected.

15. The system of claim 1, wherein said golf practice is provided with a limiting wire extending at the periphery of said golf practice and being detectable by a detector carried by the machine and wherein the automatic mobile machine reaches the station by following said limiting wire, the station being situated along said wire or on an extension thereof.

16. The system of claim 1, wherein the machine has a low profile in order to reduce the number of collisions with a ball.

17. The system of claim 1, wherein the machine has a shell made of plastic in such a manner as to be able to support the impact of golf balls.
